(19) United States
(12) Patent Application Publication
(10) Pub. No.: US 2005/0118530 A1
(43) Pub. Date: Jun. 2, 2005

(54) Optical recording medium

(75) Inventors: Koji Mishima, Tokyo (JP); Kenji Yamaga, Tokyo (JP); Hiroyasu Inoue, Tokyo (JP); Hironori Kakiuchi, Tokyo (JP); Daisuke Yoshitoku, Tokyo (JP); Hitoshi Arai, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/956,010

(22) Filed: Sep. 30, 2004

(30) Foreign Application Priority Data
Oct. 2, 2003 (JP) 2003-344254
Oct. 2, 2003 (JP) 2003-344867

(51) Int. Cl. G11B 7/24

(52) U.S. Cl. 430/270.12; 430/945; 428/64.8; 428/64.6; 369/275.5

(57) ABSTRACT

An optical recording medium includes a substrate, a light transmission layer and a recording layer formed between the substrate and the light transmission layer, the recording layer containing at least one simple substance of a metal element M selected from a group consisting of Zn and La and an element X selected from a group consisting of S and O which can combine with the metal element M to form a compound of the element X with the metal element M and the optical recording medium being constituted so that upon being irradiated with a laser beam for recording data, a crystal of the compound of the element X with the metal element M is formed and grows to form a crystal region thereof. According to the thus constituted optical recording medium, a reproduced signal having a good C/N ratio can be obtained when data recorded in the recording layer are reproduced.

### BACKGROUND OF THE INVENTION

The present invention relates to an optical recording medium and, in particular, to a write-once type optical recording medium which has excellent light resistance, can be manufactured at low cost and can reproduce a signal having a high C/N ratio.

### DESCRIPTION OF THE PRIOR ART

Optical recording disks such as the CD, DVD and the like have been widely used as recording media for recording digital data and next-generation type optical recording media having large data recording capacity and an extremely high data transfer rate has been recently actively developed.

These optical recording media can be roughly classified into ROM type optical recording disks such as the CD-ROM and the DVD-ROM that do not enable writing and rewriting of data, write-once type optical recording media such as the CD-R and DVD-R that enable writing but not rewriting of data, and data rewritable type optical recording media such as the CD-RW and DVD-RW that enable rewriting of data.

As well known in the art, data are generally recorded in a ROM type optical recording medium using pre-pits formed in a substrate in the manufacturing process thereof, while in a data rewritable type optical recording medium a phase change material is generally used as the material of the recording layer and data are recorded utilizing changes in an optical characteristic caused by phase change of the phase change material.

On the other hand, in a write-once type optical recording medium, an organic dye such as a cyanine dye, phthalocyanine dye or azo dye is generally used as the material of the recording layer and data are recorded utilizing changes in an optical characteristic caused by chemical change, physical change of the organic dye or the both of them.

However, since an organic dye is degraded when exposed to sunlight or the like, it is difficult to improve long-term storage reliability in the case where an organic dye is used as the material of the recording layer. Therefore, in order to improve the long-term storage reliability of the write-once type optical recording medium, it is necessary to form the recording layer of a material other than an organic dye. In order satisfy this requirement, Japanese Patent Application Laid Open No. 62-204442 proposes an optical recording medium whose recording layer is formed of a material other than an organic dye.

In the write-once type optical recording medium disclosed in Japanese Patent Application Laid Open No. 62-204442, a recording layer is formed by laminating two inorganic material layers and elements contained in the two inorganic material layers as a primary component are mixed with each other by projecting a laser beam onto the recording layer, thereby causing eutectic crystallization. In the case where the materials of the two laminated inorganic material layers are mixed with each other and eutectically crystallized, since the optical characteristics are different between a region where eutectic crystallization is caused and other regions, data can be recorded in the recording layer utilizing this phenomenon.

However, in the write-once type optical recording medium disclosed in Japanese Patent Application Laid Open No. 62-204442, since data are recorded by laminating two inorganic material layers and mixing materials of the two inorganic material layers, two layers are indispensable for forming a recording layer and cost for manufacturing an optical recording medium increases.

Further, in the write-once type optical recording medium disclosed in Japanese Patent Application Laid Open No. 62-204442, since the difference in optical characteristics between a recording mark formed by mixing and eutectically crystallizing materials of two inorganic material layers and other regions is not so great, it is difficult to record data in a recording layer so that a signal having good signal characteristics can be reproduced.

In particular, in a next-generation type optical recording medium having large data recording capacity and an extremely high data transfer rate, since it is required to sufficiently reduce the spot diameter of a laser beam used for recording data and reproducing data and it is required for difference in optical characteristics between a recording mark and other regions to be sufficiently great, it is extremely difficult to reproduce a signal having good signal characteristics.

### SUMMARY OF THE INVENTION

It is therefore an object of the present invention is to provide an optical recording medium which has excellent light resistance, can be manufactured at low cost and can reproduce a signal having a high C/N ratio.

The above and other objects of the present invention can be accomplished by an optical recording medium comprising a substrate, a light transmission layer and a recording layer formed between the substrate and the light transmission layer, the recording layer containing at least one simple substance of a metal element M selected from a group consisting of Ni, Cu, Si, Ti, Ge, Zr, Nb, Mo, In, Sn, W, Pb, Bi, Zn and La and an element X which can combine with the metal element M to form a compound of the element X with the metal element M and the optical recording medium being constituted so that upon being irradiated with a laser beam for recording data, a crystal of the compound of the element X with the metal element M is formed and grows to form a crystal region thereof.

According to the present invention, since the recording layer contains at least one simple substance of a metal element M selected from a group consisting of Ni, Cu, Si, Ti, Ge, Zr, Nb, Mo, In, Sn, W, Pb, Bi, Zn and La and an element X which can combine with the metal element M to form a compound of the element X with the metal element M, and is constituted as a single recording film of an inorganic material, it is possible to prevent the property of the recording layer from being degraded when exposed to sunlight or the like and data recorded in the recording layer from being degraded and cost for manufacturing an optical recording medium can be decreased.

In the present invention, when the recording layer containing the metal element M and the element X is irradiated with a laser beam for recording data, a region of the recording layer irradiated with the laser beam is heated and the metal element M contained in the recording layer as a simple substance and the element X react with each other, thereby forming crystalline grains of a compound of the metal element M and the element X. Further, an amorphous compound present around the thus formed crystalline grains of the compound of the metal element M and the element X crystallizes while the crystalline grains nucleate and crystalline grains of the compound of the metal element M and the element X is formed at the region of the recording layer irradiated with the laser beam to form a crystallized region thereof, whereby data are recorded in the recording layer. The reflectivity with respect to a laser beam of the crystallized region where crystalline grains of the compound of the metal element M and the element X are formed in this manner greatly differs from those of other regions of the recording layer. Therefore, if data are recorded in the recording layer by utilizing the crystallized region where crystalline grains of the compound of the metal element M and the element X are formed as a recording mark, a reproduced signal having a good C/N ratio can be obtained when data recorded in the recording layer are reproduced.

In a preferred aspect of the present invention, the recording layer contains an element selected from a group consisting of S and O as the element X.

If the recording layer should contain F or Cl falling in the seventh group of elements as the element X, the F or Cl would react with the metal element M even without being irradiated with a laser beam for recording data since it is very reactive, and if the recording layer should contain N or P falling in the fifth group of elements as the element X, the N or P would not readily react with the metal element M since its reactivity is very low, so that the recording sensitivity of the optical recording medium would be inferior.

To the contrary, in the case where the recording layer contains S or O falling in the sixth group of elements as the element X, the S or O can react with the metal element M in a desired manner to generate crystalline grains since the reactivity thereof is neither very high nor very low.

In a further preferred aspect of the present invention, the recording layer contains at least one metal element selected from a group consisting of Zn and La as the metal element.

In a further preferred aspect of the present invention, the recording layer further contains at least one metal element different from the metal element M and selected from a group consisting of Mg, Al, Zn and Ti.

In the present invention, in the case where the recording layer further contains Mg, it is preferable for the recording layer to contain 18.5 atomic % to 42 atomic % of Mg and it is more preferable for the recording layer to contain 20 atomic % to 37 atomic % of Mg. On the other hand, in the case where the recording layer further contains Al, it is more preferable for the recording layer to contain 11 atomic % to 70 atomic % of Al and it is more preferable for the recording layer to contain 18 atomic % to 56 atomic % of Al. Further, in the case where the recording layer further contains Ti, it is preferable for the recording layer to contain 8 atomic % to 38 atomic % of Ti and it is more preferable for the recording layer to contain 10 atomic % to 36 atomic % of Ti.

In a preferred aspect of the present invention, the optical recording medium further comprises a first water-resistant layer and a second water-resistant layer and the recording layer is formed between the first water-resistant layer and the second water-resistant layer.

According to this preferred aspect of the present invention, since the optical recording medium further comprises the first water-resistant layer and the second water-resistant layer which can prevent water from entering the recording layer, it is possible to prevent water from entering the recording layer and prevent the recording layer from being eroded by water. Therefore, it is possible to further improve the long-term storage reliability of the optical recording medium.

In a further preferred aspect of the present invention, at least one of the first water-resistant layer and the second water-resistant layer is formed so as to be in contact with the recording layer.

According to this preferred aspect of the present invention, since at least one of the first water-resistant layer and the second water-resistant layer is formed so as to be in contact with the recording layer, it is possible to effectively prevent water from entering the recording layer via the side surface of the optical recording medium and thus much more improve the long-term storage reliability of the optical recording medium.

In a further preferred aspect of the present invention, the at least one of the first water-resistant layer and the second water-resistant layer formed so as to be in contact with the recording layer contains a dielectric material as a primary component so that a recording mark whose reflectivity is different from those of other regions of the recording layer is formed in the recording layer when a laser beam for recording data is projected onto the recording layer and that at least a part of a region of the at least one of the first water-resistant layer and the second water-resistant layer in contact with the recording mark is crystallized to form a crystallized region.

According to this preferred aspect of the present invention, since in addition to the formation of the recording mark in the recording layer, at least a part of a region of the at least one of the first water-resistant layer and the second water-resistant layer in contact with the recording mark is crystallized to form a crystallized region, it is possible to increase difference between the total reflectivity of the region of the recording layer where the recording mark is formed and the crystallized region of the at least one of the first water-resistant layer and the second water-resistant layer, and those of other regions and it is therefore possible to obtain a reproduced signal having better signal characteristics.

In a further preferred aspect of the present invention, the recording layer is constituted so that data can be recorded therein and data can be reproduced therefrom using a laser beam having a wavelength of 380 nm to 450 nm.

Since the recording layer according to the present invention exhibits good optical characteristics with respect to a laser beam having a wavelength of 380 nm to 450 nm, it is preferable to record data therein and reproduce data therefrom using a laser beam having a wavelength of 380 nm to 450 nm.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is an enlarged schematic cross-sectional view of the part of the optical recording medium indicated by A in FIG. 1.

FIG. 3 is a diagram showing a pulse train pattern of a laser power control signal used for controlling the power of a laser beam when data are to be recorded in an optical recording medium.

FIG. 4 is a schematic perspective view showing an optical recording medium that is another preferred embodiment of the present invention.

FIG. 5 is an enlarged schematic cross-sectional view of the part of the optical recording medium indicated by B in FIG. 2.

FIG. 6 is a schematic cross-sectional view showing an optical recording medium shown in FIGS. 4 and 5 before data are recorded therein.

FIG. 7 is a schematic cross-sectional view showing an optical recording medium shown in FIGS. 4 and 5 after data were recorded therein.

### DESCRIPTION OF THE PREFERRED EMBODIMENTS

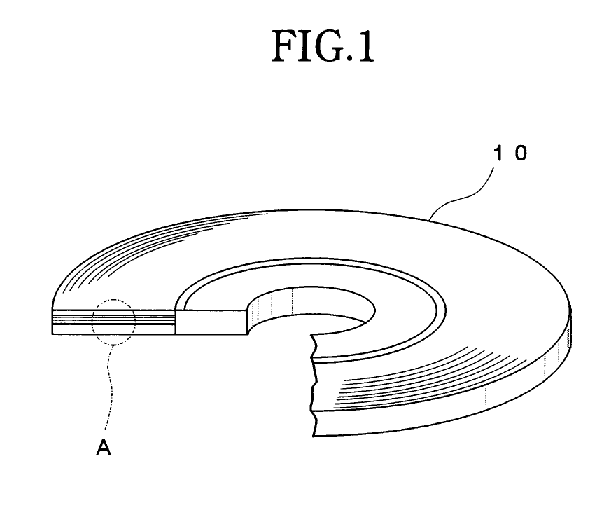

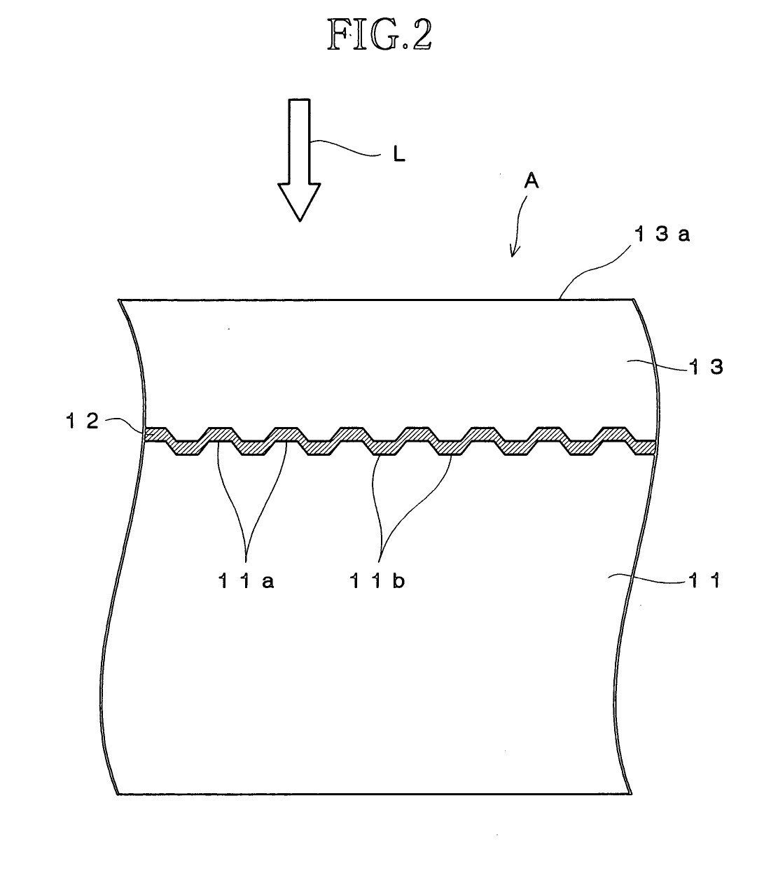

FIG. 1 is a schematic perspective view showing an optical recording medium that is a preferred embodiment of the present invention and FIG. 2 is an enlarged schematic cross-sectional view of the part of the optical recording medium indicated by A in FIG. 1.

As shown in FIG. 1, an optical recording medium 10 according to this embodiment is formed disk-like and has an outer diameter of about 120 mm and a thickness of about 1.2 mm and as shown in FIG. 2, the optical recording medium 10 includes a support substrate 11, a recording layer 12 and a light transmission layer 13.

The support substrate 11 serves as a support for ensuring mechanical strength required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin is most preferably used for forming the support substrate 11 from the viewpoint of easy processing, optical characteristics and the like, and in this embodiment the support substrate 11 is formed of polycarbonate resin. In this embodiment, since the laser beam L is projected via the light incident plane 15a located opposite to the support substrate 11, it is unnecessary for the support substrate 11 to have a light transmittance property.

In this embodiment, the support substrate 11 has a thickness of about 1.1 mm.

As shown in FIG. 2, grooves 11a and lands 11b are alternately and spirally formed on the surface of the support substrate 11. The grooves 11a and/or lands 11b serve as a guide track for the laser beam L when data are to be recorded in the recording layer 12 and data are reproduced from the recording layer 12.

As shown in FIG. 2, the recording layer 12 is formed on the surface of the support substrate 11.

In this embodiment, the recording layer 12 contains at least one metal element M selected from a group consisting of Zn and La and an element X selected from a group consisting of S and O.

The recording layer 12 preferably has a thickness of 8 nm to 60 nm and more preferably has a thickness of 10 nm to 45 nm.

In the case where the recording layer 12 is thinner than 8 nm, it is difficult to sufficiently improve the C/N ratio of a signal obtained by reproducing data recorded in the recording layer 12 and on the other hand, in the case where the recording layer 12 is thicker than 60 nm, a long time is required for forming the recording layer 12 and the productivity of the optical recording medium 10 is lowered.

In this embodiment, since the recording layer 12 contains at least one metal element M selected from a group consisting of Zn and La and an element X selected from a group consisting of S and O and is constituted as a single film, it is possible to simultaneously improve the long-term storage reliability of an optical recording medium 10 and reduce cost of an optical recording medium 10.

The light transmission layer 13 serves transmit a laser beam L and a light incidence plane 13a is constituted by one of the surfaces thereof.

It is preferable to form the light transmission layer 13 so as to have a thickness of 10 μm to 300 μm and it is more preferable to form it so as to have a thickness of 50 μm to 150 μm.

Since a laser beam L passes through the light transmission layer 13 when data are to be recorded in or data are to be reproduced from the recording layer 12, it is necessary for the light transmission layer 13 to have sufficiently high light transmittance.

The material for forming the light transmission layer 13 is not particularly limited and an ultraviolet ray curable acrylic resin or an ultraviolet ray curable epoxy resin is preferably used for forming the light transmission layer 13.

The optical recording medium 10 having the above-described configuration can, for example, be fabricated in the following manner.

The support substrate 11 having the groove 11a and the land 11b on the surface thereof is first fabricated by injection molding using a stamper (not shown).

Then, the recording layer 12 containing at least one metal element M selected from a group consisting of Zn and La and an element X selected from a group consisting of S and O is formed on the surface of the support substrate 11 on which the groove 11a and the land 1b are formed.

In this embodiment, the recording layer 12 further contains at least one metal element different from the metal element M and selected from a group consisting of Mg, Al, Zn and Ti.

Concretely, the recording layer 12 is formed on the surface of the support substrate 11 by a sputtering process using a target containing ZnS.SiO₂ or La.Si.O.N as a primary component and a target containing at least one metal element different from the metal element M and selected from a group consisting of Mg, Al, Zn and Ti a primary element.

In this specification, ZnS.SiO₂ means a mixture of ZnS and SiO₂, and La.Si.O.N means a mixture of La, Si, O and N.

In the case where the recording layer 12 is formed by a sputtering process using a target containing ZnS.SiO₂ or La.Si.O.N as a primary component and a target containing at least one metal element different from the metal element M and selected from a group consisting of Mg, Al, Zn and Ti as a primary element, the at least one metal element different from the metal element M and selected from a group consisting of Mg, Al, Zn and Ti acts on ZnS.SiO₂ or La.Si.O.N as a reducing agent and, as a result, the metal element Zn or La comes to be present in the form of a simple substance in the recording layer 12.

Concretely, in the case where a target containing ZnS SiO₂ as a primary component and a target containing Mg as a primary component are used, Mg acts on ZnS contained in ZnS.SiO₂ and as a result, a simple substance of Zn is uniformly dispersed in the recording layer 12. At this time, Mg used as a reducing agent binds with S separated from ZnS or contained in ZnS, thereby forming MgS. Therefore, of Zn is contained in the recording layer 12 as a simple substance.

In this embodiment, in the case where the recording layer 12 contain ZnS.SiO₂ as a primary element, the mole ratio of ZnS and SiO₂ contained in the recording layer 12 is preferably 40:60 to 80:20 and more preferably 65:35 to 75:25.

In the case where the mole ratio of ZnS in ZnS.SiO₂ contained in the recording layer 12 is equal to or larger than 40%, the reflectivity and light transmittance of the recording layer 12 with respect to a laser beam L can be simultaneously improved and in the case where the mole ratio of ZnS in ZnS.SiO₂ is equal to or smaller than 80%, it is possible to reliably prevent cracks from being generated in the recording layer 12. Further, if the mole ratio of ZnS and SiO₂ is set to 65:35 to 75:25, the reflectivity and light transmittance of the recording layer 12 with respect to a laser beam L can be simultaneously further improved while enabling generation of cracks in the recording layer 12 to be more reliably prevented.

On the other hand, in the case where the recording layer 12 is formed by a sputtering process using a target containing La.Si.O.N as a primary component, La.Si.O.N consisting of SiO₂, Si₃N₄ and La₂O₃ is used and the mole ratio of SiO₂ and the sum of Si₃N₄ and La₂O₃ is preferably 10:90 to 50:50 and the mole ratio of SiO₂, Si₃N₄ and La₂O₃ is preferably 30:50:20.

In the case where the mole ratio of SiO₂ in La.Si.O.N contained in the target as a primary component is less than 10%, cracks are liable to be generated in the recording layer 12 and in the case where the mole ratio of SiO₂ in La.Si.O.N exceeds 50%, the refractive index of the recording layer 12 decreases and the reflectivity thereof decreases. On the other hand, in the case where the mole ratio of the sum of Si₃N₄ and La₂O₃ in La.Si.O.N is 50% to 90%, a recording layer 12 having a high refractive index can be formed and it is possible to prevent cracks from being generated in the recording layer 12. Therefore, it is preferable to set the mole ratio of SiO₂, Si₃N₄ and La₂O₃ in La.Si.O.N contained in a target to 30:50:20.

Further, it is more preferable to set the mole ratio of Si₃N₄ in La.Si.O.N contained in the target as a primary component to be equal to or more than 30% and the mole ratio of La₂O₃ in La.Si.O.N to be equal to or more than 50% since residual stress in the recording layer 12 caused when it is formed can be reduced.

Furthermore, in this embodiment, in the case where the recording layer 12 contains Mg, it is preferable for the recording layer 12 to contain 18.5 atomic % to 42 atomic % of Mg and it is more preferable for the recording layer 12 to contain 20.0 atomic % to 37 atomic % of Mg. On the other hand, in the case where the recording layer 12 contains Al, it is more preferable for the recording layer 12 to contain 11 atomic % to 70 atomic % of Al and it is more preferable for the recording layer 12 to contain 18 atomic % to 56 atomic % of Al. Further, in the case where the recording layer 12 contains Ti, it is preferable for the recording layer 12 to contain 8 atomic % to 38 atomic % of Ti and it is more preferable for the recording layer 12 to contain 10 atomic % to 36 atomic % of Ti.

Then, an ultraviolet ray curable resin is applied onto the surface of the recording layer 12 using a spin coating method to form a coating layer and the coating layer is irradiated with an ultraviolet ray, whereby the light transmission layer 13 is formed.

This completes the fabrication of the optical recording medium 10.

Data are recorded in the thus constituted optical recording medium 10 as follows.

When data are to be recorded in the optical recording medium 10, a laser beam L having a wavelength of 380 nm to 450 nm is projected onto the recording layer 12 via the light incidence plane 13a of the light transmission layer 13 and is focused onto the recording layer 12.

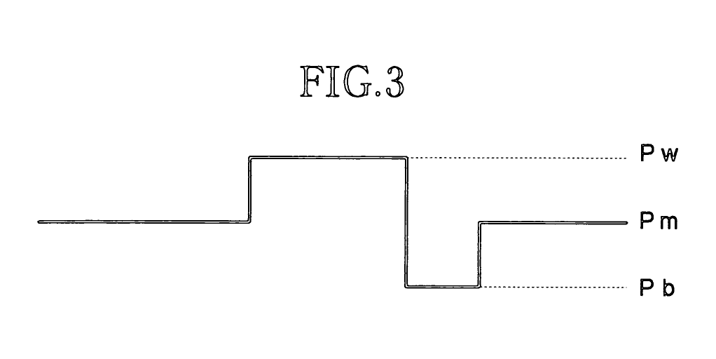

FIG. 3 is a diagram showing a pulse train pattern of a laser power control signal used for controlling the power of a laser beam L when data are to be recorded in the recording layer 12 of the optical recording medium 10.

As shown in FIG. 3, the pulse train pattern of a laser power control signal used for recording data in the recording layer 12 of the optical recording medium 10 includes pulses whose power is modulated between three levels, namely, the level corresponding to a recording power Pw, the level corresponding to an intermediate power Pm and the level corresponding to a bottom power Pb. The recording power Pw, the intermediate power Pm and the bottom power Pb satisfy the relationship Pw>Pm≧Pb and the three levels of the pulse train pattern are determined correspondingly.

When data are to be recorded in the recording layer 12, a laser beam L whose power is modulated in accordance with a laser power control signal of the pulse train pattern shown in FIG. 3 is projected onto the recording layer 12 via the light transmission layer 13.

When the laser beam L is projected onto the recording layer 12 in this manner, the phase of the recording layer 12 is changed, whereby data are recorded in the recording layer 12.

More specifically, when the laser beam L whose power is set to the recording power Pw, the recording layer 12 is heated and the metal element Zn or La contained in the recording layer 12 in the form of an amorphous simple substance reacts with S or O at a region of the heated recording layer 12 to form crystalline ZnS or La₂O₃ grains. Further, the crystalline ZnS or La₂O₃ grains nucleate and amorphous ZnS or La₂O₃ present around the crystalline ZnS or La₂O₃ grains crystallizes. Since the region where the crystalline ZnS or La₂O₃ grains have been formed in this manner has a different reflection coefficient with respect to the laser beam having a wavelength of 380 nm to 450 nm from those other regions of the recording layer 12, it can be used as a record mark and data are recorded in the recording layer 12.

Therefore, according to this embodiment, when data recorded in the recording layer 12 is reproduced, a reproduced signal having a good C/N ratio can be obtained.

Here, the level of the recording power Pw of the laser beam L is set to such a level that the metal element Zn or La and the element S or O contained in the recording layer 12 can reliably bind with each other to form crystalline ZnS or La₂O₃ grains.

On the other hand, the levels of the intermediate power Pm and the bottom power Ph of the laser beam L are set to such low levels that the metal element Zn or La and the element S or O contained in the recording layer 12 cannot bind with each other.

In particular, the level of the bottom power Ph of the laser beam L is set to such a low level that the region of the recording layer 12 heated by irradiation with the laser beam L can be quickly cooled when the power of the laser beam L is switched to the bottom power Ph.

Thus, data are recorded in the recording layer 12 of the optical recording medium 10.

According to this embodiment, since the recording layer 12 contains at least one metal element M selected from a group consisting of Zn and La and an element X selected from a group consisting of S and O and is constituted as a single film, it is possible to simultaneously improve the long-term storage reliability of an optical recording medium 10 and reduce cost of an optical recording medium 10.

Further, according to this embodiment, the metal element Zn or La and the element S or O contained in the recording layer 12 bind with each other to form crystalline ZnS or La₂O₃ grains, whereby data are recorded in the recording layer 12 and since it is possible to increase difference in the reflectivity to the laser beam L between the region of the recording layer 12 where crystalline ZnS or La₂O₃ grains have been formed and other regions thereof, it is possible to obtain a reproduced signal having a good C/N ratio.

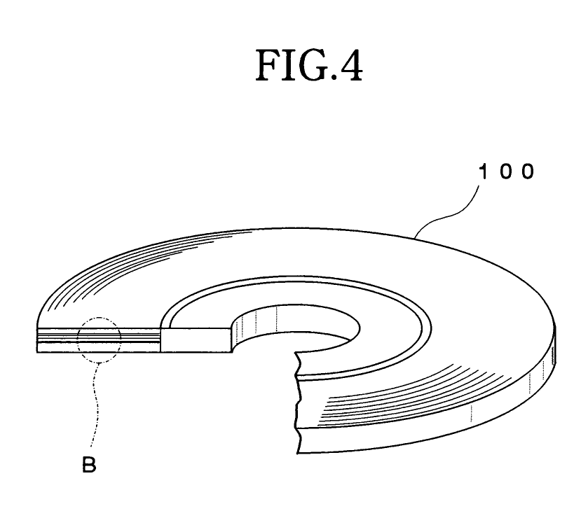

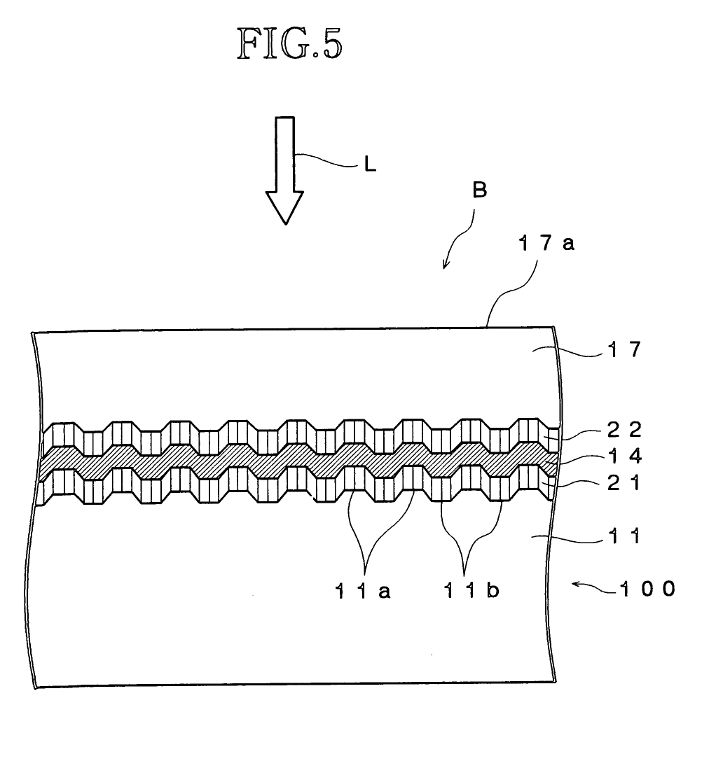

FIG. 4 is a schematic perspective view showing an optical recording medium that is another preferred embodiment of the present invention and FIG. 5 is an enlarged schematic cross-sectional view of the part of the optical recording medium indicated by B in FIG. 2.

As shown in FIG. 5, the optical recording medium 100 according to this embodiment includes a support substrate 11, a first water-resistant layer 21 formed on the surface of the support substrate 11, a recording layer 14 formed on the surface of the first water-resistant layer 21, a second water-resistant layer 22 formed on the surface of the recording layer 14 and a light transmission layer 17 formed on the surface of the second water-resistant layer 22.

In this embodiment, as shown in FIG. 5, the first water-resistant layer 21 is formed on the surface of the support substrate 11 on which grooves 11a and lands 11b are formed and the second water-resistant layer 22 is formed on the surface of the recording layer 14 so that they are formed to be in contact with the recording layer 14.

The first water-resistant layer 21 serves to prevent water from entering the recording layer 14 from the outside of the optical recording medium 100 via the support substrate 11 and as a part of the recording layer 14.

The material used for forming the first water-resistant layer 21 is not particularly limited insofar as it is a dielectric material which can prevent water from entering the recording layer 14 and crystallize when a region of the recording layer 14 in contact therewith crystallizes and the first water-resistant layer 21 can be formed of a dielectric material containing oxide, sulfide, nitride, fluoride or the combination thereof as a primary component.

Concretely, it is preferable for the first water-resistant layer 21 to contain as a primary component oxide, sulfide, nitride, fluoride or a complex compound thereof containing at least one metal selected from a group consisting of Ni, Ge, Nb, Mo, In, W, Bi, La, Si, Zn, Al, Ta, Ti, Co, Zr, Pb, Ag, Sn, Ca, Ce, V, Cu, Fe and Mg. For example, it is particularly preferable for the first water-resistant layer 21 to contain as a primary component the metal element contained in the adjacent recording layer 14 and a dielectric material containing the element S or O as a primary component, or ZnS.SiO₂.

The first water-resistant layer 21 can be formed on the surface of the support substrate 11 by a vapor phase growth process using chemical species containing elements for forming the first water-resistant layer 21. Illustrative examples of the vapor phase growth processes include vacuum deposition process, sputtering process and the like.

It is preferable to form the first water-resistant layer 21 so as to have a thickness of 20 nm to 150 nm and it is more preferable to form the first water-resistant layer 21 so as to have a thickness of 30 nm to 120 nm.

In the case where the first water-resistant layer 21 is thinner than 20 nm, it is impossible to form the first water-resistant layer 21 to have the required water resistant ability and, on the other hand, in the case where the first water-resistant layer 21 is thicker than 150 nm, a long time is required for forming the first water-resistant layer 21 and there arises a risk of the productivity of the optical recording medium 100 being lowered.

As shown in FIG. 5, the recording layer 14 is formed on the surface of the first water-resistant layer 21.

The recording layer 14 can be formed so as to have the same composition and thickness as those of the recording layer 12 of the optical recording medium 10 shown in FIGS. 1 and 2 in the same manner as that of the recording layer 12.

As shown in FIG. 5, the second water-resistant layer 22 is formed on the surface of the recording layer 14.

The second water-resistant layer 22 serves to prevent water from entering the recording layer 14 from the outside of the optical recording medium 100 via the light transmission layer 17 and as a part of the recording layer 14.

The material used for forming the second water-resistant layer 22 is not particularly limited insofar as it is a dielectric material which can prevent water from entering the recording layer 14 and crystallize when a region of the recording layer 14 in contact therewith crystallizes and the second water-resistant layer 22 can be formed of the same materials as those of the first water-resistant layer 21.

The first water-resistant layer 21 and the second water-resistant layer 22 may be formed of the same dielectric material but may also be formed of different dielectric materials.

The second water-resistant layer 22 can be formed on the surface of the recording layer 14 by a vapor phase growth process using chemical species containing elements for forming the second water-resistant layer 22. Illustrative examples of the vapor phase growth processes include vacuum deposition process, sputtering process and the like.

It is preferable to form the second water-resistant layer 22 so as to have a thickness of 20 nm to 150 nm and it is more preferable to form the second water-resistant layer 22 so as to have a thickness of 30 nm to 120 nm.

In the case where the second water-resistant layer 22 is thinner than 20 nm, it is impossible to form the second water-resistant layer 22 to have the required water resistant ability and on the other hand, in the case where the second water-resistant layer 22 is thicker than 150 nm, a long time is required for forming the second water-resistant layer 22 and there arises a risk of the productivity of the optical recording medium 100 being lowered.

Since a laser beam L passes through the second water-resistant layer 22 when data are to be recorded in the recording layer 14 or data recorded in the recording layer 14 are to be reproduced, it is necessary for the second water-resistant layer 22 to have sufficient light transmittance.

As shown in FIG. 5, the light transmission layer 17 is formed on the surface of the second water-resistant layer 22.

The light transmission layer 17 serves transmit a laser beam L and a light incidence plane 17a is constituted by one of the surfaces thereof.

The light transmission layer 17 can be formed so as to have the same composition and thickness as those of the light transmission layer 13 of the optical recording medium 10 shown in FIGS. 1 and 2 in the same manner as that of the light transmission layer 13.

Data are recorded in the thus constituted optical recording medium 100 as follows.

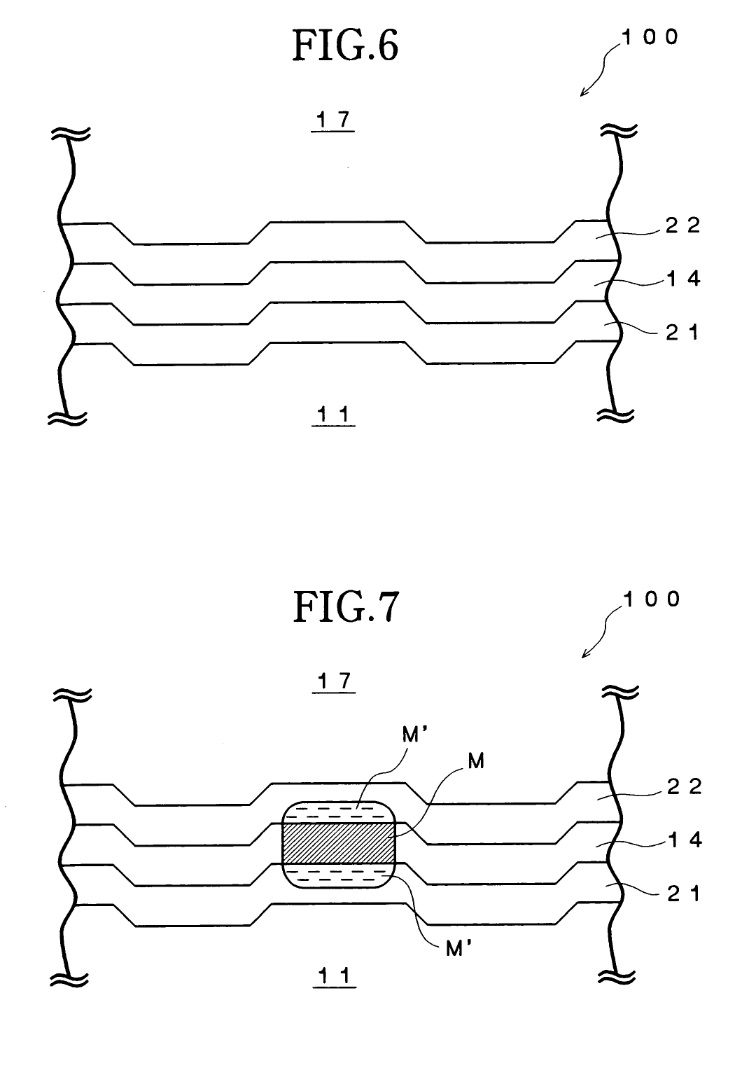

FIG. 6 is a schematic cross-sectional view showing the optical recording medium 100 before data are recorded therein and FIG. 7 is a schematic cross-sectional view showing the optical recording medium 100 after data were recorded therein.

Recording of data in the optical recording medium 100 is performed similarly to the recording of data in the optical recording medium 10 shown in FIGS. 1 and 2, i.e., a laser beam L whose power is modulated is projected onto the recording layer 14 via the light transmission layer 17 and the second water-resistant layer 22.

When the laser beam L is projected onto the recording layer 14 in this manner, the recording layer 14 is heated and, similarly to the case of the optical recording medium 10 shown in FIGS. 1 and 2, the metal element Zn or La contained in the recording layer 14 in the form of an amorphous simple substance reacts with S or O at a region of the heated recording layer 14 to form crystalline ZnS or La₂O₃ grains. Further, the crystalline ZnS or La₂O₃ grains nucleate and amorphous ZnS or La₂O₃ present around the crystalline ZnS or La₂O₃ grains crystallizes.

Thus, as shown in FIG. 7, a region where the compound ZnS or La₂O₃ of the metal element Zn or La and the element S or O crystallizes is formed and a recording mark M is formed in the recording layer 14.

Further, in this embodiment, when the laser beam L is projected onto the recording layer 14 and the recording mark M is formed, a dielectric material contained at regions of the first water-resistant layer 21 and the second water-resistant layer 22 in contact with the region of the recording layer 14 where the recording mark M is formed crystallizes and, as shown in FIG. 7, crystallized regions M′ are formed in the first water-resistant layer 21 and the second water-resistant layer 22 so as to be adjacent to the region of the recording layer 14 where the recording mark M is formed.

Although it is not altogether clear why the dielectric material contained at regions of the first water-resistant layer 21 and the second water-resistant layer 22 in contact with the region of the recording layer 14 where the recording mark M is formed crystallize when the laser beam L is projected onto the recording layer 14 and the recording mark M is formed, it is reasonable to assume that when the laser beam L is projected onto the recording layer 14, whereby the crystalline ZnS or La₂O₃ grains nucleate and amorphous ZnS or La₂O₃ present around the crystalline ZnS or La₂O₃ grains crystallizes, a crystallizing reaction occurs in the first water-resistant layer 21 and the second water-resistant layer 22, whereby the dielectric material contained in the first water-resistant layer 21 and the second water-resistant layer 22 is crystallized from the interfaces between the recording layer 14 and the first water-resistant layer 21 and the second water-resistant layer 22 toward insides of the first water-resistant layer 21 and the second water-resistant layer 22 so that the crystallized regions M′ are formed therein.

Thus, in this embodiment, the recording mark M is formed in the recording layer 24 and, in addition, crystallized regions M′ are formed in the regions of the first water-resistant layer 21 and the second water-resistant layer 22 adjacent to the region of the recording layer 14 where the recording mark M is formed. Therefore, the difference between the reflectivities of the region where the recording mark M is formed and the crystallized regions M′ and those of other regions increases in total, and a reproduced signal having better characteristics can be obtained.

According to this embodiment, since the recording layer 14 contains at least one metal element M selected from a group consisting of Zn and La and an element X selected from a group consisting of S and O and is constituted as a single film, it is possible to simultaneously improve the long-term storage reliability of the optical recording medium 100 and reduce cost of the optical recording medium 100.

Further, according to this embodiment, the metal element Zn or La and the element S or O contained in the recording layer 14 bind with each other to form crystalline ZnS or La₂O₃ grains, whereby data are recorded in the recording layer 14 and since it is possible to increase difference in the reflectivity to the laser beam L between the region of the recording layer 14 where crystalline ZnS or La₂O₃ grains have been formed and other regions thereof, it is possible to obtain a reproduced signal having a good C/N ratio.

Furthermore, according to this embodiment, since the first water-resistant layer 21 is formed between the support substrate 11 and the recording layer 14 and the second water-resistant layer 22 is formed between the light transmission layer 17 and the recording layer 14, it is possible to prevent water from entering the recording layer 14 from the outside of the optical recording medium 100 via the support substrate 11 or the light transmission layer 17. Therefore, since it is possible to effectively prevent the recording layer 14 from being corroded by water, it is possible to further improve the long-term storage reliability of the optical recording medium 100.

### WORKING EXAMPLES

Hereinafter, working examples will be set out in order to further clarify the advantages of the present invention.

### Working Example 1

An optical recording disc sample # 1 was fabricated in the following manner.

A polycarbonate substrate having a thickness of 1.1 mm and a diameter of 120 mm and formed with grooves and lands on the surface thereof was first fabricated by an injection molding process so that the groove pitch was equal to 0.32 μm.

Then, the polycarbonate substrate was set on a sputtering apparatus and a recording layer having a thickness of 30 nm was formed on the surface of the polycarbonate substrate on which the grooves and lands were formed by the sputtering process using a target containing ZnS as a primary component and a target containing Mg as a primary component.

The composition of the thus formed recording layer was measured by the FP method using a fluorescent X-ray apparatus “RIX2000” (Product Name) manufactured by Rigaku Corporation, by generating an X-ray under conditions of an X-ray tube voltage of the Rh tube of 50 kV and an X-ray tube current of 50 mA. It was found that the resulting recording layer contained 39.1 atomic % of Zn, 47.0 atomic % of S and 13.9 atomic % of Mg.

Further, the recording layer was coated using the spin coating method with acrylic ultraviolet ray curable resin to form a coating layer and the coating layer was irradiated with ultraviolet rays, thereby curing the acrylic ultraviolet ray curable resin to form a light transmission layer having a thickness of 100 μm.

Thus, the optical recording medium sample # 1 was fabricated.

Then, an optical recording disk sample # 2 was fabricated in the manner of the optical recording disk sample # 1 except that the electric power used in the sputtering process was changed and the recording layer was formed so as to contain 35.8 atomic % of Zn, 44.2 atomic % of S and 20.0 atomic % of Mg.

Further, an optical recording disk sample # 3 was fabricated in the manner of the optical recording disk sample # 1 except that the electric power used in the sputtering process was changed and the recording layer was formed so as to contain 32.9 atomic % of Zn, 42.8 atomic % of S and 24.3 atomic % of Mg.

Then, an optical recording disk sample # 4 was fabricated in the manner of the optical recording disk sample # 1 except that the electric power used in the sputtering process was changed and the recording layer was formed so as to contain 28.9 atomic % of Zn, 37.6 atomic % of S and 33.5 atomic % of Mg.

Further, an optical recording disk sample # 5 was fabricated in the manner of the optical recording disk sample # 1 except that the electric power used in the sputtering process was changed and the recording layer was formed so as to contain 29.9 atomic % of Zn, 30.2 atomic % of S and 39.9 atomic % of Mg.

Then, an optical recording disk sample # 6 was fabricated in the manner of the optical recording disk sample # 1 except that the electric power used in the sputtering process was changed and the recording layer was formed so as to contain 25.2 atomic % of Zn, 25.7 atomic % of S and 49.1 atomic % of Mg.

Further, an optical recording disk sample # 7 was fabricated in the manner of the optical recording disk sample # 1 except that the electric power used in the sputtering process was changed and the recording layer was formed so as to contain 20.4 atomic % of Zn, 20.3 atomic % of S and 59.3 atomic % of Mg.

Then, the optical recording disk sample # 1 was set in an optical recording medium evaluation apparatus “DDU1000” (Product Name) manufactured by Pulstec Industrial Co., Ltd. and data were recorded as follows.

A blue laser beam having a wavelength of 405 nm was used as a laser beam for recording data and the laser beam was condensed onto the recording layer via the light transmission layer using an objective lens having a numerical aperture of 0.85, thereby forming record marks each having a length of 2T in the (1,7) RLL Modulation Code and record marks each having a length of 8T in the recording layer under the following signal recording conditions.

As a laser power control signal for controlling the power of the laser beam, the pulse train pattern shown in FIG. 3 was used so that the recording power Pw of the laser beam was set to 3 mW.

Further, data were recorded in the recording layer by increasing the recording power Pw of the laser beam little by little in the range of 3 mW to 12 mW.
Modulation Code: (1,7) RLL
Linear recording velocity: 5.3 m/sec
Channel bit length: 0.12 μm
Channel clock: 66 MHz
Recording Track: On-groove recording

Then, the laser beam whose power was set to the reproducing power was projected onto the recording layer of the optical recording disk sample # 1 using the above mentioned optical recording medium evaluation apparatus, thereby reproducing data recorded in the recording layer and the C/N ratio of a signal obtained by reproducing data recorded by forming record marks each having a length of 8T was measured.

When data were to be reproduced, a laser beam having a wavelength of 405 nm and an objective lens whose numerical aperture NA was 0.85 were employed and the reproducing power of the laser beam was set to 0.3 mW.

Further, the recording power Pw of the laser beam at which the C/N ratio of a signal obtained by varying the recording power Pw of the laser beam from 3 mW to 12 mW and reproducing data recorded in the recording layer of the optical recording disk sample # 1 was minimum was measured and the C/N ratio of a signal obtained by reproducing data recorded in the recording layer of the optical recording disk sample # 1 at the recording power Pwwere measured.

The results of the measurement are shown in Table 1.

Then, the recording layer of each of the optical recording disc samples # 2 to # 7 was irradiated with a laser beam using the above mentioned optical recording medium evaluation apparatus and similarly to the optical recording disc sample #1, recording marks each having a length of 8T were formed in the recording layer of each sample, thereby recording data therein.

Here, similarly to the case where data were recorded in the recording layer of the optical recording disc sample #1, data were recorded in the recording layer of each of the optical recording disc samples # 2 to # 7 by increasing the recording power Pw of the laser beam little by little in the range of 3 mW to 12 mW.

Then, data recorded in the recording layer of each of the optical recording disc samples # 2 to # 7 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of each of the optical recording disk samples # 2 to # 7 was minimum was measured and the C/N ratio of a signal obtained by reproducing data recorded in the recording layer of each of the optical recording disk samples # 2 to # 7 at the recording power Pw were measured.

The results of the measurement are shown in Table 1.

TABLE 1

| | | | | recording | |
|---|---|---|---|---|---|
| | composition (atomic %) | | | power | 8T C/N |
| | Zn | S | Mg | (mW) | (dB) |
| sample # 1 | 39.1 | 47.0 | 13.9 | 12 | 10.6 |
| sample # 2 | 35.8 | 44.2 | 20.0 | 12 | 41.3 |
| sample # 3 | 32.9 | 42.8 | 24.3 | 9 | 48.9 |
| sample # 4 | 28.9 | 37.6 | 33.5 | 6 | 48.9 |
| sample # 5 | 29.9 | 30.2 | 39.9 | 6 | 40.9 |
| sample # 6 | 25.2 | 25.7 | 49.1 | 6 | 35.7 |
| sample # 7 | 20.4 | 20.3 | 59.3 | 8 | 36.6 |

As shown in Table 1, it was found that in each of the optical recording disc samples # 2 to # 5 whose Mg content in the recording layer was 20 atomic % to 40 atomic %, the C/N ratio of a signal obtained by reproducing data recorded in the recording layer was equal to or higher than 40 dB and a reproduced signal having an extremely high C/N ratio could be obtained.

To the contrary, it was found that in the optical recording disc sample # 1 whose Mg content in the recording layer was less than 20 atomic %, the C/N ratio of a signal obtained by reproducing data recorded in the recording layer was 10.6 dB and in each of the optical recording disc samples # 6 and # 7 whose Mg content in the recording layer was more than 40 atomic %, the C/N ratio of a signal obtained by reproducing data recorded in the recording layer exceeded 30 dB.

Then, the state of the recording layer of the optical recording disk sample # 3 was inspected as follows.

First, optical recording disk samples # 3-1, # 3-2 and # 3-3 were fabricated in the manner of the optical recording disk sample # 3 and data were recorded in a part of the recording layer of each of the optical recording disk samples # 3-1, # 3-2 and # 3-3 similarly to the case of recording data in the optical recording disk sample # 3.

The optical recording disk sample # 3-1 was incised using a cutter to peel the light transmission layer, thereby exposing the recording layer to the outside. Then, a dielectric film having a thickness of 20 nm and containing Al₂O₃ as a primary component and a metal film having a thickness of 100 nm and containing Al as a primary component were sequentially formed on the exposed recording layer by the sputtering process.

Then, a hole having a diameter of about 2 mm was formed in the dielectric film and the metal film of the optical recording disk sample # 3-1 by locally sputtering the surface of the metal film, thereby exposing the recording layer to the outside.

Further, energy spectrums in a region of the recording layer of the optical recording disk sample # 3-1 where a record mark was formed and a region thereof where no record mark was formed were measured using an Auger spectrum analysis apparatus “SAM680” (Product Name) manufactured by ALVAC-PHI, Inc. under the following measurement conditions.
Acceleration voltage: 5 kV
Tilt: 30 degrees
Sample current: 10 mA
Ar ion beam sputter-etching acceleration voltage: 2 kV

The energy spectrum in which a metal energy spectrum and a compound energy spectrum appeared to be mixed was measured at the region where no record mark was formed and, on the other hand, only the compound energy spectrum was measured at the region where the record mark was formed.

Then, the optical recording disk sample # 3-2 was incised using a cutter to remove the light transmission layer and the recording layer and the thus removed light transmission layer and the recording layer were bonded onto a slide glass using an ultraviolet ray curable resin in such a manner that the light transmission layer was brought into contact with the slide glass.

Further, light absorption coefficients with respect to a laser beam having a wavelength of 405 nm of a region of the recording layer of the optical recording disk sample # 3-2 where the record mark was formed and a region thereof where no record mark was formed were measured using an optical film thickness measuring apparatus “ETA-RT” (Product Name) manufactured by STEAG ETA-Optik Co, Ltd.

The light absorption coefficient of the region where no record mark was formed was 17% and that of the region where the record mark was formed was 13%.

It was reasonable to conclude that the light absorption coefficient of the region where the record mark was formed was lower than that of the region where no record mark was formed because free electrons of Zn absorbing much light combined with S to form a compound, whereby the number of free electrons of Zn decreased in the region where the record mark was formed.

Then, the optical recording disk sample # 3-3 was cut using a microtome to form a sample for a transmission electron microscope and the electron diffraction pattern of the fourth recording layer was measured using a transmission electron microscope “JEM-3010” (Product Name) manufactured by JEOL LTD. The acceleration voltage was set to 300 kV.

As a result, a broad electron diffraction ring of ZnS was observed at the region of the recording layer of the optical recording disk sample # 3-3 where no record mark was formed and, on the other hand, the electron diffraction spots of ZnS were observed at the region thereof where the record mark was formed.

From the above experiments, it was reasonable to conclude that Zn was present in the form of a simple substance and a compound with S at the region of the recording layer where no record mark was formed, namely, the recording layer before data were recorded, and that crystals of ZnS formed by the combination of Zn and S were present at the region of the recording layer where the record mark was formed, namely, the recording layer after data were recorded.

### Working Example 2

An optical recording disc sample # 8 was fabricated in the manner of the optical recording disk sample # 1 except that the recording layer was formed using a target containing Al as a primary component instead of the target containing Mg as a primary component.

The composition of the recording layer of the optical recording disk sample # 8 was measured similarly to in Working Example 1. It was found that the recording layer of the optical recording disk sample # 8 contained 39.7 atomic % of Zn, 50.3 atomic % of S and 10.0 atomic % of Al.

Then, an optical recording disk sample # 9 was fabricated in the manner of the optical recording disk sample # 8 except that the electric power used in the sputtering process was changed and the recording layer was formed so as to contain 35.7 atomic % of Zn, 45.4 atomic % of S and 18.9 atomic % of Al.

Further, an optical recording disk sample # 10 was fabricated in the manner of the optical recording disk sample # 8 except that the electric power used in the sputtering process was changed and the recording layer was formed so as to contain 29.7 atomic % of Zn, 39.0 atomic % of S and 31.3 atomic % of Al.

Then, an optical recording disk sample # 11 was fabricated in the manner of the optical recording disk sample # 8 except that the electric power used in the sputtering process was changed and the recording layer was formed so as to contain 25.3 atomic % of Zn, 33.5 atomic % of S and 41.2 atomic % of Al.

Further, an optical recording disk sample # 12 was fabricated in the manner of the optical recording disk sample # 8 except that the electric power used in the sputtering process was changed and the recording layer was formed so as to contain 22.0 atomic % of Zn, 22.4 atomic % of S and 55.5 atomic % of Mg.

Then, an optical recording disk sample # 13 was fabricated in the manner of the optical recording disk sample # 8 except that the electric power used in the sputtering process was changed and the recording layer was formed so as to contain 13.9 atomic % of Zn, 13.7 atomic % of S and 72.5 atomic % of Al.

Further, each of the optical recording disk samples # 8 to # 13 was set in the above mentioned optical recording medium evaluation apparatus and similarly to in Working Example 1, recording marks each having a length of 8T were formed in the recording layer of each sample, thereby recording data therein.

Here, similarly to in Working Example 1, data were recorded in the recording layer of each of the optical recording disc samples # 8 to # 13 by increasing the recording power Pw of the laser beam little by little in the range of 3 mW to 12 mW.

Then, similarly to in Working Example 1, data recorded in the recording layer of each of the optical recording disk samples # 8 to # 13 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of each of the optical recording disk samples # 8 to # 13 was minimum was measured and the C/N ratio of a signal obtained by reproducing data recorded in the recording layer of each of the optical recording disk samples # 8 to # 13 at the recording power Pw were measured.

The results of the measurement are shown in Table 2.

TABLE 2

| | | | | recording | |
|---|---|---|---|---|---|
| | composition (atomic %) | | | power | 8T C/N |
| | Zn | S | Al | (mW) | (dB) |
| sample # 8 | 39.7 | 50.3 | 110.0 | 12 | 30.8 |
| sample # 9 | 35.7 | 45.4 | 18.9 | 12 | 44.6 |
| sample # 10 | 29.7 | 39.0 | 31.3 | 7 | 48.9 |
| sample # 11 | 25.3 | 33.5 | 41.2 | 5 | 42.2 |
| sample # 12 | 22.0 | 22.4 | 55.5 | 4 | 43.6 |
| sample # 13 | 13.9 | 13.7 | 72.5 | 5 | 35.0 |

As shown in Table 2, it was found that in each of the optical recording disc samples # 9 to # 12 whose Al content in the recording layer was 18 atomic % to 56 atomic %, the C/N ratio of a signal obtained by reproducing data recorded in the recording layer was equal to or higher than 40 dB and a reproduced signal having an extremely high C/N ratio could be obtained.

To the contrary, it was found that in the optical recording disc sample # 8 whose Al content in the recording layer was less than 18 atomic % and the optical recording disc sample # 13 whose Al content in the recording layer was more than 56 atomic %, the C/N ratio of a signal obtained by reproducing data recorded in the recording layer exceeded 30 dB but was lower than 40 dB.

### Working Example 3

An optical recording disc sample # 14 was fabricated in the manner of the optical recording disk sample # 1 except that the recording layer was formed using a target containing Ti as a primary component instead of the target containing Mg as a primary component.

The composition of the recording layer of the optical recording disk sample # 14 was measured similarly to in Working Example 1. It was found that the recording layer of the optical recording disk sample # 14 contained 43.6 atomic % of Zn, 48.8 atomic % of S and 7.6 atomic % of Ti.

Then, an optical recording disk sample # 15 was fabricated in the manner of the optical recording disk sample # 14 except that the electric power used in the sputtering process was changed and the recording layer was formed so as to contain 41.8 atomic % of Zn, 47.9 atomic % of S and 10.3 atomic % of Ti.

Further, an optical recording disk sample # 16 was fabricated in the manner of the optical recording disk sample # 14 except that the electric power used in the sputtering process was changed and the recording layer was formed so as to contain 38.3 atomic % of Zn, 46.9 atomic % of S and 14.8 atomic % of Ti.

Then, an optical recording disk sample # 17 was fabricated in the manner of the optical recording disk sample # 14 except that the electric power used in the sputtering process was changed and the recording layer was formed so as to contain 35.7 atomic % of Zn, 42.2 atomic % of S and 22.1 atomic % of Ti.

Further, an optical recording disk sample # 18 was fabricated in the manner of the optical recording disk sample # 14 except that the electric power used in the sputtering process was changed and the recording layer was formed so as to contain 30.8 atomic % of Zn, 33.8 atomic % of S and 35.4 atomic % of Ti.

Then, an optical recording disk sample # 19 was fabricated in the manner of the optical recording disk sample # 14 except that the electric power used in the sputtering process was changed and the recording layer was formed so as to contain 28.2 atomic % of Zn, 32.5 atomic % of S and 39.3 atomic % of Ti.

Further, each of the optical recording disk samples # 14 to # 19 was set in the above mentioned optical recording medium evaluation apparatus and similarly to in Working Example 1, recording marks each having a length of 8T were formed in the recording layer of each sample, thereby recording data therein.

Here, similarly to in Working Example 1, data were recorded in the recording layer of each of the optical recording disc samples # 14 to # 19 by increasing the recording power Pw of the laser beam little by little in the range of 3 mW to 12 mW.

Then, similarly to in Working Example 1, data recorded in the recording layer of each of the optical recording disk samples # 14 to # 19 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of each of the optical recording disk samples # 14 to # 19 was minimum was measured and the C/N ratio of a signal obtained by reproducing data recorded in the recording layer of each of the optical recording disk samples # 14 to # 19 at the recording power Pw were measured.

The results of the measurement are shown in Table 3.

TABLE 3

| | | | | recording | |
|---|---|---|---|---|---|
| | composition (atomic %) | | | power | 8T C/N |
| | Zn | S | Ti | (mW) | (dB) |
| sample # 14 | 43.6 | 48.8 | 7.6 | 12 | 18.9 |
| sample # 15 | 41.8 | 47.9 | 10.3 | 12 | 41.6 |
| sample # 16 | 38.3 | 46.9 | 14.8 | 7 | 47.3 |
| sample # 17 | 35.7 | 42.2 | 22.1 | 5 | 50.1 |
| sample # 18 | 30.8 | 33.8 | 35.4 | 4 | 41.1 |
| sample # 19 | 28.2 | 32.5 | 39.3 | 5 | 38.2 |

As shown in Table 3, it was found that in each of the optical recording disc samples # 15 to # 18 whose Ti content in the recording layer was 10 atomic % to 36 atomic %, the C/N ratio of a signal obtained by reproducing data recorded in the recording layer was equal to or higher than 40 dB and a reproduced signal having an extremely high C/N ratio could be obtained.

To the contrary, it was found that in the optical recording disc sample # 14 whose Ti content in the recording layer was less than 10 atomic %, the C/N ratio of a signal obtained by reproducing data recorded in the recording layer was 18.6 dB and in the optical recording disc sample # 19 whose Ti content in the recording layer was more than 36 atomic %, the C/N ratio of a signal obtained by reproducing data recorded in the recording layer exceeded 30 dB but was lower than 40 dB.

### Working Example 4

An optical recording disc sample # 20 was fabricated in the manner of the optical recording disk sample # 1 except that the recording layer was formed using a target containing a mixture of ZnS and SiO₂ whose mole ratio was 80:20 as a primary component instead of the target containing Mg as a primary component.

The composition of the recording layer of the optical recording disk sample # 20 was measured similarly to in Working Example 1. It was found that the recording layer of the optical recording disk sample # 20 contained 21.8 atomic % of Zn, 10.8 atomic % of Si, 18.3 atomic % of Mg, 21.6 atomic % of 0 and 27.5 atomic % of S. Since 0 was contained in the polycarbonate substrate, the content of 0 was determined to be about double the content of Si, assuming that 0 combined with Si to form SiO₂.

Then, an optical recording medium # 21 was fabricated in the manner of the optical recording disk sample # 20 except that the electric power used in the sputtering process was changed and the recording layer was formed so as to contain 21.5 atomic % of Zn, 10.1 atomic % of Si, 20.8 atomic % of Mg, 20.1 atomic % of 0 and 27.5 atomic % of S.

Further, an optical recording disk sample # 22 was fabricated in the manner of the optical recording disk sample # 20 except that the electric power used in the sputtering process was changed and the recording layer was formed so as to contain 22.6 atomic % of Zn, 9.3 atomic % of Si, 25.0 atomic % of Mg, 18.6 atomic % of 0 and 24.5 atomic % of S.

Then, an optical recording medium # 23 was fabricated in the manner of the optical recording disk sample # 20 except that the electric power used in the sputtering process was changed and the recording layer was formed so as to contain 19.1 atomic % of Zn, 8.0 atomic % of Si, 33.9 atomic % of Mg, 16.0 atomic % of 0 and 23.0 atomic % of S.

Further, an optical recording disk sample # 24 was fabricated in the manner of the optical recording disk sample # 20 except that the electric power used in the sputtering process was changed and the recording layer was formed so as to contain 18.9 atomic % of Zn, 7.3 atomic % of Si, 37.0 atomic % of Mg, 14.5 atomic % of 0 and 22.3 atomic % of S.

Then, an optical recording medium # 25 was fabricated in the manner of the optical recording disk sample # 20 except that the electric power used in the sputtering process was changed and the recording layer was formed so as to contain 16.1 atomic % of Zn, 7.1 atomic % of Si, 42.5 atomic % of Mg, 14.2 atomic % of 0 and 20.1 atomic % of S.

Further, each of the optical recording disk samples # 20 to # 25 was set in the above mentioned optical recording medium evaluation apparatus and similarly to in Working Example 1, recording marks each having a length of 8T were formed in the recording layer of each sample, thereby recording data therein.

Here, similarly to in Working Example 1, data were recorded in the recording layer of each of the optical recording disc samples # 20 to # 25 by increasing the recording power Pw of the laser beam little by little in the range of 3 mW to 12 mW.

Then, similarly to in Working Example 1, data recorded in the recording layer of each of the optical recording disk samples # 20 to # 25 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of each of the optical recording disk samples # 20 to # 25 was minimum was measured and the C/N ratio of a signal obtained by reproducing data recorded in the recording layer of each of the optical recording disk samples # 20 to # 25 at the recording power Pw were measured.

The results of the measurement are shown in Table 4.

TABLE 4

| | composition (atomic %) | | | | | recording | 8T C/N |
|---|---|---|---|---|---|---|---|
| | Zn | Si | Mg | O | S | power (mW) | (dB) |
| sample # 20 | 21.8 | 10.8 | 18.3 | 21.6 | 27.5 | 12 | 30.0 |
| sample # 21 | 21.5 | 10.1 | 20.8 | 20.1 | 27.5 | 12 | 47.6 |
| sample # 22 | 22.6 | 9.3 | 25.0 | 18.6 | 24.5 | 6 | 54.4 |
| sample # 23 | 19.1 | 8.0 | 33.9 | 16.0 | 23.0 | 6 | 53.8 |
| sample # 24 | 18.9 | 7.3 | 37.0 | 14.5 | 22.3 | 6 | 45.7 |
| sample # 25 | 16.1 | 7.1 | 42.5 | 14.2 | 20.1 | 5 | 37.9 |

As shown in Table 4, it was found that in each of the optical recording disc samples # 21 to # 24 whose Mg content in the recording layer was 20 atomic % to 40 atomic %, the C/N ratio of a signal obtained by reproducing data recorded in the recording layer was equal to or higher than 40 dB and a reproduced signal having an extremely high C/N ratio could be obtained.

To the contrary, it was found that in the optical recording disc sample # 20 whose Mg content in the recording layer was less than 20 atomic % and the optical recording disc sample # 25 whose Mg content in the recording layer was more than 40 atomic %, the C/N ratio of a signal obtained by reproducing data recorded in the recording layer exceeded 30 dB but was lower than 40 dB.

### Working Example 5

An optical recording disc sample # 26 was fabricated in the manner of the optical recording disk sample # 1 except that the recording layer was formed using a target containing a mixture of ZnS and SiO₂ whose mole ratio was 50:50 as a primary component instead of the target containing ZnS as a primary component.

The composition of the recording layer of the thus fabricated optical recording disk sample # 26 was measured similarly to in Working Example 1. It was found that the recording layer of the optical recording disk sample # 26 contained 14.5 atomic % of Zn, 16.6 atomic % of Si, 17.8 atomic % of Mg, 33.2 atomic % of 0 and 17.9 atomic % of S. Since 0 was contained in the polycarbonate substrate, the content of 0 was determined to be about double the content of Si, assuming that 0 combined with Si to form SiO₂.

Then, an optical recording medium # 27 was fabricated in the manner of the optical recording disk sample # 26 except that the electric power used in the sputtering process was changed and the recording layer was formed so as to contain 13.1 atomic % of Zn, 15.9 atomic % of Si, 22.3 atomic % of Mg, 31.8 atomic % of 0 and 16.9 atomic % of S.

Further, an optical recording disk sample # 28 was fabricated in the manner of the optical recording disk sample # 26 except that the electric power used in the sputtering process was changed and the recording layer was formed so as to contain 12.9 atomic % of Zn, 15.0 atomic % of Si, 26.1 atomic % of Mg, 30.0 atomic % of 0 and 16.0 atomic % of S.

Then, an optical recording medium # 29 was fabricated in the manner of the optical recording disk sample # 26 except that the electric power used in the sputtering process was changed and the recording layer was formed so as to contain 11.8 atomic % of Zn, 13.2 atomic % of Si, 32.8 atomic % of Mg, 26.4 atomic % of 0 and 15.8 atomic % of S.

Further, an optical recording disk sample # 30 was fabricated in the manner of the optical recording disk sample # 26 except that the electric power used in the sputtering process was changed and the recording layer was formed so as to contain 9.5 atomic % of Zn, 10.7 atomic % of Si, 46.2 atomic % of Mg, 21.4 atomic % of 0 and 12.2 atomic % of S.

Then, each of the optical recording disk samples # 26 to # 30 was set in the above mentioned optical recording medium evaluation apparatus and similarly to in Working Example 1, recording marks each having a length of 8T were formed in the recording layer of each sample, thereby recording data therein.

Here, similarly to in Working Example 1, data were recorded in the recording layer of each of the optical recording disc samples # 26 to # 30 by increasing the recording power Pw of the laser beam little by little in the range of 3 mW to 12 mW.

Then, similarly to in Working Example 1, data recorded in the recording layer of each of the optical recording disk samples # 26 to # 30 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of each of the optical recording disk samples # 26 to # 30 was minimum was measured and the C/N ratio of a signal obtained by reproducing data recorded in the recording layer of each of the optical recording disk samples # 26 to # 30 at the recording power Pw were measured.

The results of the measurement are shown in Table 5.

TABLE 5

| | composition (atomic %) | | | | | recording | 8T C/N |
|---|---|---|---|---|---|---|---|
| | Zn | Si | Mg | O | S | power (mW) | (dB) |
| sample # 26 | 14.5 | 16.6 | 17.8 | 33.2 | 17.9 | 12 | 16.6 |
| sample # 27 | 13.1 | 15.9 | 22.3 | 31.8 | 16.9 | 12 | 45.4 |
| sample # 28 | 12.9 | 15.0 | 26.1 | 30.0 | 16.0 | 8 | 49.4 |
| sample # 29 | 11.8 | 13.2 | 32.8 | 26.4 | 15.8 | 5 | 45.0 |
| sample # 30 | 9.5 | 10.7 | 46.2 | 21.4 | 12.2 | 4 | 35.0 |

As shown in Table 5, it was found that in each of the optical recording disc samples # 27 to # 29 whose Mg content in the recording layer was 20 atomic % to 35 atomic %, the C/N ratio of a signal obtained by reproducing data recorded in the recording layer was equal to or higher than 40 dB and a reproduced signal having an extremely high C/N ratio could be obtained.

To the contrary, it was found that in the optical recording disc sample # 26 whose Mg content in the recording layer was less than 20 atomic %, the C/N ratio of a signal obtained by reproducing data recorded in the recording layer was 16.6 dB and in the optical recording disc sample # 30 whose Mg content in the recording layer was more than 35 atomic %, the C/N ratio of a signal obtained by reproducing data recorded in the recording layer exceeded 30 dB but was lower than 40 dB.

### Working Example 6

An optical recording disc sample # 31 was fabricated in the manner of the optical recording disk sample # 1 except that the recording layer was formed using a target containing a mixture of La₂O₃, SiO₂ and Si₃N₄ whose mole ratio was 20:30:50 as a primary component instead of the target containing ZnS as a primary component.

The composition of the recording layer of the thus fabricated optical recording disk sample # 31 was measured similarly to in Working Example 1. It was found that the recording layer of the optical recording disk sample # 31 contained 6.2 atomic % of La, 24.1 atomic % of Si, 23.1 atomic % of Mg, 24.6 atomic % of 0 and 22.0 atomic % of N. Since 0 was contained in the polycarbonate substrate, the content of 0 was determined to be about double the content of Si, assuming that 0 combined with Si to form SiO₂.

Then, the optical recording disk sample # 31 was set in the above mentioned optical recording medium evaluation apparatus and similarly to in Working Example 1, recording marks each having a length of 8T were formed in the recording layer, thereby recording data therein.

Here, similarly to in Working Example 1, data were recorded in the recording layer of the optical recording disc sample # 31 by increasing the recording power Pw of the laser beam little by little in the range of 3 mW to 12 mW.

Then, similarly to in Working Example 1, data recorded in the recording layer of the optical recording disk sample # 31 were reproduced using the above mentioned optical recording medium evaluation apparatus and the C/N ratio of a signal obtained by reproducing data recorded by forming record marks each having a length of 8T was measured.

Further, the recording power Pw of the laser beam at which the C/N ratio of a signal obtained by varying the recording power Pw of the laser beam from 3 mW to 12 mW and reproducing data recorded in the recording layer of the optical recording disk sample # 31 was minimum was measured and the C/N ratio of a signal obtained by reproducing data recorded in the recording layer of the optical recording disk sample # 31 at the recording power Pw were measured.

The results of the measurement are shown in Table 6.

TABLE 6

| | composition (atomic %) | | | | | recording | 8T C/N |
|---|---|---|---|---|---|---|---|
| | La | Si | Mg | O | N | power (mW) | (dB) |
| sample # 31 | 6.2 | 24.1 | 23.1 | 24.6 | 22.0 | 9 | 51.6 |

As shown in Table 6, it was found that in the optical recording disk sample # 31, the C/N ratio of a signal obtained by reproducing data recorded in the recording layer was equal to or higher than 40 dB and a reproduced signal having an extremely high C/N ratio could be obtained.

### Working Example 7

An optical recording disc sample # 32 was fabricated in the following manner.

A polycarbonate substrate having a thickness of 1.1 mm and a diameter of 120 mm and formed with grooves and lands on the surface thereof was first fabricated by an injection molding process so that the groove pitch was equal to 0.32 μm.

Then, the polycarbonate substrate was set on a sputtering apparatus and a first water-resistant layer having a thickness of 80 nm was formed on the surface of the polycarbonate substrate on which the grooves and lands were formed by the sputtering process using a target containing a mixture of ZnS and SiO₂ as a primary component.

The mole ratio of ZnS to SiO₂ in the mixture of ZnS and SiO₂ contained in the target was 80:20.

Then, the polycarbonate substrate formed with the second water-resistant layer was set on the sputtering apparatus and a recording layer having a thickness of 32 nm was formed on the surface of the second water-resistant layer by the sputtering process using a target containing a mixture of ZnS and SiO₂ as a primary component and as target containing Mg as a primary component.

The mole ratio of ZnS to SiO₂ in the mixture of ZnS and SiO₂ contained in the target was 80:20.

The composition of the thus formed recording layer was measured similarly to in Working Example 1. It was found that the recording layer contained 23.0 atomic % of Zn, 9.0 atomic % of Si, 25.0 atomic % of Mg, 19.0 atomic % of 0 and 24.0 atomic % of S.

Further, a first water-resistant layer having a thickness of 85 nm was formed on the surface of the recording layer by the sputtering process using a target containing a mixture of ZnS and SiO₂ as a primary component.

The mole ratio of ZnS to SiO₂ in the mixture of ZnS and SiO₂ contained in the target was 80:20.

Finally, the first water-resistant layer was coated using the spin coating method with acrylic ultraviolet ray curable resin to form a coating layer and the coating layer was irradiated with ultraviolet rays, thereby curing the acrylic ultraviolet ray curable resin to form a light transmission layer having a thickness of 100 μm.

Thus, the optical recording medium sample # 32 was fabricated.

Then, an optical recording disc sample # 33 was fabricated in the following manner.

A polycarbonate substrate fabricated in the manner of fabricating the optical recording medium sample # 32 was set on the sputtering apparatus and a recording layer having a thickness of 32 nm was formed on the surface of the polycarbonate substrate by the sputtering process using a target containing a mixture of ZnS and SiO₂ as a primary component and as target containing Mg as a primary component.

The mole ratio of ZnS to SiO₂ in the mixture of ZnS and SiO₂ contained in the target was 80:20.

The composition of the thus formed recording layer was measured similarly to in Working Example 1. It was found that the recording layer contained 23.0 atomic % of Zn, 9.0 atomic % of Si, 25.0 atomic % of Mg, 19.0 atomic % of 0 and 24.0 atomic % of S.

Then, the recording layer was coated using the spin coating method with acrylic ultraviolet ray curable resin to form a coating layer and the coating layer was irradiated with ultraviolet rays, thereby curing the acrylic ultraviolet ray curable resin to form a light transmission layer having a thickness of 100 μm.

Thus, the optical recording medium sample # 33 was fabricated.

Each of the thus fabricated optical recording medium samples # 32 and # 33 was set in an optical recording medium evaluation apparatus “DDU1000” (Product Name) manufactured by Pulstec Industrial Co., Ltd. and data were recorded as follows.

A blue laser beam having a wavelength of 405 nm was used as a laser beam for recording data and the laser beam was condensed onto the recording layer of each of the optical recording medium samples # 32 and # 33 via the light transmission layer using an objective lens having a numerical aperture of 0.85, thereby forming record marks each having a length of 2T in the (1,7) RLL Modulation Code and record marks each having a length of 8T in the recording layer under the following signal recording conditions.

As a laser power control signal for controlling the power of the laser beam, the pulse train pattern shown in FIG. 3 was used so that the recording power Pw of the laser beam was set to 6 mW.
Modulation Code: (1,7) RLL
Linear recording velocity: 5.3 m/sec
Channel bit length: 0.12 μm
Channel clock: 66 MHz
Recording Track: On-groove recording

Then, a laser beam which had a wavelength of 405 nm and whose power was set to the reproducing power was projected onto the recording layer of each of the optical recording disk samples # 32 and #33 using the above mentioned optical recording medium evaluation apparatus, thereby reproducing data recorded in the recording layer and modulation and the C/N ratio of a reproduced signal were measured using a spectrum analyzer “spectrum analyzer XK180” (Product Name) manufactured by Advantest Corporation.

The modulation of a reproduced signal was defined as the value obtained by dividing the level of the reproduced signal obtained by subtracting the level of the reproduced signal obtained by projecting a laser beam for reproducing data onto a region of the recording layer where a recording mark was formed from the level of the reproduced signal obtained by projecting the laser beam onto a region of the recording layer where no recording mark was formed by the level of the reproduced signal obtained by projecting the laser beam onto the region of the recording layer where no recording mark was formed.

The level of the reproducing power was set to 0.3 mW.

The results of the measurement are shown in Table 7.

TABLE 7

| | modulation (%) | C/N ratio (dB) |
|---|---|---|
| sample # 32 | 50.5 | 56.6 |
| sample # 33 | 42.3 | 54.0 |

As shown in Table 7, it was found that the modulation of signals obtained by reproducing data recorded in the recording layers of the optical recording disc samples # 32 and # 33 were 50.5% and 42.3%, respectively and that the modulation of the reproduced signal was markedly improved in the optical recording disc sample # 32 in comparison with that in the optical recording disc sample # 33.

Further, as shown in Table 7, it was found that C/N ratios of signals obtained by reproducing data recorded in the recording layers of the optical recording disc samples # 32 and # 33 were 56.6 dB and 54.0 dB, respectively and that the C/N ratio of the reproduced signal was markedly improved in the optical recording disc sample # 32 in comparison with that in the optical recording disc sample # 33.

### Working Example 8

Each of the optical recording disc samples # 32 and # 33 in which recording marks each having a length of 8T in the (1,7) RLL Modulation Code were formed in the recording layers, thereby recording data therein was held in air at a temperature of 80° C. and relative humidity of 85% for fifty hours, thereby performing a storage test.

After the storage test, data recorded in each of the optical recording disc samples # 32 and # 33 were reproduced using the above mentioned optical recording medium evaluation apparatus and the C/N ratio of the reproduced signal was measured using the above mentioned spectrum analyzer.

The results of the measurement are shown in Table 8.

In Table 8, the C/N ratios obtained in Working Example 7 are shown as “Values before storage test.”

TABLE 8

C/N (dB)

| | before storage test | after storage test |
|---|---|---|
| sample # 32 | 56.6 | 56.1 |
| sample # 33 | 54.0 | not measurable |

As shown in Table 8, it was found that the C/N ratio of a reproduced signal could not be measured when data recorded in the optical recording disc sample # 33 were reproduced after the storage test, but that in the case of the optical recording disc sample # 32, the C/N ratio of a signal obtained by reproducing data recorded in the recording layer before the storage test and that after the storage test were 56.6 dB and 56.1, respectively, i.e., the C/N ratio of the signal reproduced after the storage test was almost the same as that before the storage test. In other words, it was found that the long-term storage reliability of the optical recording disc sample # 32 was higher than that of the optical recording disc sample # 33.

The present invention has thus been shown and described with reference to specific embodiments and working examples. However, it should be noted that the present invention is in no way limited to the details of the described arrangements but changes and modifications may be made without departing from the scope of the appended claims.

For example, although the recording layer 12 contains at least one metal element M selected from a group consisting of Zn and La in the embodiment shown in FIGS. 1 and 2 and the recording layer 14 contains at least one metal element M selected from a group consisting of Zn and La in the embodiment shown in FIGS. 4 and 5, it is not absolutely necessary for the recording layer 12, 14 to contain at least one metal element M selected from a group consisting of Zn and La and the recording layer 12, 14 may contain at least one of metal element M selected from a group consisting of Ni, Cu, Si, Ti, Ge, Zr, Nb, Mo, In, Sn, W, Pb and Bi instead of Zn or La.

Further, although the recording layer 12 is formed by the sputtering process using the target containing ZnS.SiO₂ or La.Si.O.N as a primary component and the target containing at least one metal component different from the metal element M and selected from a group consisting of Mg, Al, Zn and Ti in the embodiment shown in FIGS. 1 and 2 and the recording layer 14 is similarly formed by the sputtering process using the target containing ZnS.SiO₂ or La.Si.O.N as a primary component and the target containing at least one metal element different from the metal element M and selected from a group consisting of Mg, Al, Zn and Ti in the embodiment shown in FIGS. 4 and 5, it is sufficient for the recording layer 12, 14 to contain a metal element M selected from the group consisting of Zn and La and an element X capable of binding with the metal element X to form a crystal of a compound of the metal element M and the element X and selected from the group consisting of S and O in the form of a simple substance and it is not absolutely necessary to form the recording layer 12, 14 by the sputtering process using the target containing ZnS.SiO₂ or La.Si.O.N as a primary component and the target containing at least one metal element different from the metal element M and selected from a group consisting of Mg, Al, Zn and Ti. For example, it is possible to form a recording layer 12, 14 by sputtering process using a target containing ZnS as a primary component and a target containing at least one metal element different from the metal element M and selected from a group consisting of Mg, Al, Zn and Ti.

Furthermore, in the embodiment shown in FIGS. 1 and 2 and the embodiment shown in FIGS. 4 and 5, although the light incidence plane 14a, 17a through which the laser beam L enters is formed by the light transmission layer 14, 17, it is possible to form a hard coat layer containing a hard coat composition as a primary component on the surface of a light transmission layer 13, 17 and to form a hard coat layer containing a lubricant for adding a lubricant property and contamination-resistant property to the hard coat layer. In addition, it is possible to form a separate lubricant layer containing a lubricant as a primary component on the surface of the hard coat layer.

Moreover, in the embodiment shown in FIGS. 4 and 5, although each of the first water-resistant layer 21 and the second water-resistant layer 21 is formed of a dielectric material which can prevent water from entering the recording layer 14 and crystallizes when a region of the recording layer 14 in contact therewith crystallizes, each of the first water-resistant layer 21 and the second water-resistant layer 21 may serve solely to prevent water from entering the recording layer 14. In such a case, it is sufficient for the material used for forming the first water-resistant layer 21 and the second water-resistant layer 21 to have a property of preventing water from entering the recording layer 14 and it is not absolutely necessary for it to have a property of crystallizing when a region of the recording layer 14 in contact therewith crystallizes. Therefore, the first water-resistant layer 21 and the second water-resistant layer 21 can be formed by a resin material using a coating process or the like.

Further, in the embodiment shown in FIGS. 4 and 5, although each of the first water-resistant layer 21 and the second water-resistant layer 21 is formed in contact with the recording layer 14 so that crystallized regions M′ can be formed at regions thereof in contact with a recording mark M formed in the recording layer 14, it is not absolutely necessary for each of the first water-resistant layer 21 and the second water-resistant layer 21 to be formed in contact with the recording layer 14 so that crystallized regions M′ can be formed at regions thereof in contact with a recording mark M formed in the recording layer 14 and it is possible to form only one of the first water-resistant layer 21 and the second water-resistant layer 21 to be in contact with the recording layer 14 so that a crystallized region M′ can be formed only in the water-resistant layer formed in contact with the recording layer 14.

Furthermore, in the embodiment shown in FIGS. 4 and 5, although each of the first water-resistant layer 21 and the second water-resistant layer 21 is formed in contact with the recording layer 14, it is not absolutely necessary for each of the first water-resistant layer 21 and the second water-resistant layer 21 to be formed in contact with the recording layer 14 and it is possible to interpose another layer(s) such as a transparent intermediate layer between both or either of the first water-resistant layer 21 and the second water-resistant layer 21 and the recording layer 14.

Moreover, in the embodiment shown in FIGS. 4 and 5, although the first water-resistant layer 21 is formed between the support substrate 11 and the recording layer 14, it is not absolutely necessary to form the first water-resistant layer 21 between the support substrate 11 and the recording layer 14 and the first water-resistant layer 21 may be formed on the side opposite to the recording layer 14 with respect to the support substrate 11.

Further, in the embodiment shown in FIGS. 4 and 5, although the first water-resistant layer 21 is formed between the support substrate 11 and the recording layer 14, it is possible to omit the first water-resistant layer 21 if a support substrate 11 is formed of polystyrene resin, polyolefin resin or the like having a water-resistant property or a water-absorbing property.

Furthermore, in the embodiment shown in FIGS. 4 and 5, although the optical recording medium 100 includes the first water-resistant layer 21 formed of a dielectric material between the support substrate 11 and the recording layer 14, it is possible to form the first water-resistant layer 21 of a metal element so that the first water-resistant layer 21 can also serve as a reflective film.

Moreover, in the above described embodiments, although the optical recording medium 10, 100 is constituted so that the laser beam L is projected onto the recording layer 12, 14 via the light transmission layer 13, 17, it is not absolutely necessary for an optical recording medium of the present invention to be constituted in such a manner and an optical recording medium of the present invention may be a DVD type optical recording medium including a light transmittable substrate having a thickness of about 0.6 mm, a dummy substrate having a thickness of about 0.6 mm and a recording layer between the light transmittable substrate and the dummy substrate.

According to the present invention, it is possible to provide an optical recording medium which has excellent light resistance, can be manufactured at low cost and can reproduce a signal having a high C/N ratio.

1. An optical recording medium comprising a substrate, a light transmission layer and a recording layer formed between the substrate and the light transmission layer, the recording layer containing at least one simple substance of a metal element M selected from a group consisting of Ni, Cu, Si, Ti, Ge, Zr, Nb, Mo, In, Sn, W, Pb, Bi, Zn and La and an element X which can combine with the metal element M to form a compound of the element X with the metal element M and the optical recording medium being constituted so that upon being irradiated with a laser beam for recording data, a crystal of the compound of the element X with the metal element M is formed and grows to form a crystal region thereof.

2. An optical recording medium in accordance with claim 1, wherein the recording layer contains an element selected from a group consisting of S and O as the element X.

3. An optical recording medium in accordance with claim 1, wherein the recording layer further contains at least one metal element different from the metal element M and selected from a group consisting of Mg, Al, Zn and Ti.

4. An optical recording medium in accordance with claim 2, wherein the recording layer further contains at least one metal element different from the metal element M and selected from a group consisting of Mg, Al, Zn and Ti.

5. An optical recording medium in accordance with claim 1, which further comprises a first water-resistant layer and a second water-resistant layer and the recording layer is formed between the first water-resistant layer and the second water-resistant layer.

6. An optical recording medium in accordance with claim 2, which further comprises a first water-resistant layer and a second water-resistant layer and the recording layer is formed between the first water-resistant layer and the second water-resistant layer.

7. An optical recording medium in accordance with claim 3, which further comprises a first water-resistant layer and a second water-resistant layer and the recording layer is formed between the first water-resistant layer and the second water-resistant layer.

8. An optical recording medium in accordance with claim 4, which further comprises a first water-resistant layer and a second water-resistant layer and the recording layer is formed between the first water-resistant layer and the second water-resistant layer.

9. An optical recording medium in accordance with claim 5, wherein at least one of the first water-resistant layer and the second water-resistant layer is formed so as to be in contact with the recording layer.

10. An optical recording medium in accordance with claim 6, wherein at least one of the first water-resistant layer and the second water-resistant layer is formed so as to be in contact with the recording layer.

11. An optical recording medium in accordance with claim 7, wherein at least one of the first water-resistant layer and the second water-resistant layer is formed so as to be in contact with the recording layer.

12. An optical recording medium in accordance with claim 8, wherein at least one of the first water-resistant layer and the second water-resistant layer is formed so as to be in contact with the recording layer.

13. An optical recording medium in accordance with claim 9, wherein the at least one of the first water-resistant layer and the second water-resistant layer formed so as to be in contact with the recording layer contains a dielectric material as a primary component so that a recording mark whose reflectivity is different from those of other regions of the recording layer is formed in the recording layer when a laser beam for recording data is projected onto the recording layer and that at least a part of a region of the at least one of the first water-resistant layer and the second water-resistant layer in contact with the recording mark is crystallized to form a crystallized region.

14. An optical recording medium in accordance with claim 10, wherein the at least one of the first water-resistant layer and the second water-resistant layer formed so as to be in contact with the recording layer contains a dielectric material as a primary component so that a recording mark whose reflectivity is different from those of other regions of the recording layer is formed in the recording layer when a laser beam for recording data is projected onto the recording layer and that at least a part of a region of the at least one of the first water-resistant layer and the second water-resistant layer in contact with the recording mark is crystallized to form a crystallized region.

15. An optical recording medium in accordance with claim 11, wherein the at least one of the first water-resistant layer and the second water-resistant layer formed so as to be in contact with the recording layer contains a dielectric material as a primary component so that a recording mark whose reflectivity is different from those of other regions of the recording layer is formed in the recording layer when a laser beam for recording data is projected onto the recording layer and that at least a part of a region of the at least one of the first water-resistant layer and the second water-resistant layer in contact with the recording mark is crystallized to form a crystallized region.

16. An optical recording medium in accordance with claim 12, wherein the at least one of the first water-resistant layer and the second water-resistant layer formed so as to be in contact with the recording layer contains a dielectric material as a primary component so that a recording mark whose reflectivity is different from those of other regions of the recording layer is formed in the recording layer when a laser beam for recording data is projected onto the recording layer and that at least a part of a region of the at least one of the first water-resistant layer and the second water-resistant layer in contact with the recording mark is crystallized to form a crystallized region.

17. An optical recording medium in accordance with claim 1, wherein the recording layer is constituted so that data can be recorded therein and data can be reproduced therefrom using a laser beam having a wavelength of 380 nm to 450 nm.

18. An optical recording medium in accordance with claim 5, wherein the recording layer is constituted so that data can be recorded therein and data can be reproduced therefrom using a laser beam having a wavelength of 380 nm to 450 nm.
